(19) United States
(12) Patent Application Publication
(10) Pub. No.: US 2026/0357953 A1
(43) Pub. Date: Nov. 12, 2026

(54) DISPENSER OF CRYOGENIC LIQUID

(71) Applicant: GRAF Industries S.p.A., Nonantola, Modena (IT)

(72) Inventors: Mario MORMILE, Nonantola, Modena (IT); Marco Antonino PALELLA, Nonantola, Modena (IT)

(73) Assignee: GRAF Industries S.p.A., Nonantola, Modena (IT)

(21) Appl. No.: 19/132,011

(22) PCT Filed: Nov. 20, 2023
(86) PCT No.: PCT/IB2023/061692

§ 371 Date: May 22, 2025

(30) Foreign Application Priority Data
Nov. 23, 2022 (IT) 102022000024099

(51) Int. Cl. F17C 13/10

(52) U.S. Cl. CPC F17C 13/10; F17C 2205/0376; F17C 2223/0161; F17C 2225/0161; F17C 2260/032; F17C 2265/065; F17C 2270/0139

(57) ABSTRACT

The dispenser (1) of cryogenic liquid comprises:
one dispensing apparatus (2) fastened onto the ground and connected to a supply assembly of a cryogenic liquid in a fluid-operated manner;
one dispensing gun (5) associated with the dispensing apparatus (2), connectable to a feeding tank and adapted to dispense the cryogenic liquid into the tank;
one heat treatment assembly (10) associated with the dispensing apparatus (2) and adapted to heat at least partly the dispensing gun (5) to obtain at least the melting of ice formed on the dispensing gun (5) as a result of the dispensing of the cryogenic liquid.

### TECHNICAL FIELD

The present invention relates to a dispenser of cryogenic liquid.

The present invention also relates to a holder for a dispensing gun of cryogenic liquid.

Cryogenics is that particular branch of technology concerning the study, production and use of products stored at very low temperatures.

### Background Art

It is well known to subject some products naturally occurring in the gaseous state to cryogenic treatments which generally consist of successive stages of cooling and condensation causing such gaseous products to liquefy.

Such a state passage allows the specific volume of a gas to be reduced from its specific volume under standard conditions, thus allowing it to be contained in a much smaller space than is necessary to store it under standard conditions.

It is common practice to transport and store some gases widely used in human activities, such as, e.g., natural gas, hydrogen and nitrogen in the form of cryogenic liquids.

With particular reference to natural gas, its use is well known as an energy source, especially for heating buildings, and as a fuel for transport vehicle engines, especially heavy wheeled vehicles.

Natural gas for the latter use is stored and transported in the form of Liquefied Natural Gas (LNG) and is an odorless, transparent liquid having a boiling temperature of about −160 °C at atmospheric pressure.

Vehicles operating on liquefied natural gas comprise a supply assembly provided with a tank, adapted to contain the liquefied natural gas, and with a supply line, connected to the tank in a fluid-operated manner and adapted to convey the natural gas to the engine of the vehicle.

Natural gas is introduced into the vehicle tank in liquefied form and is used by the engine in gaseous form; therefore, the supply line is provided with a heating unit into which the liquefied natural gas enters to be heated and to return to the gaseous state before reaching the engine.

For this reason, the supply line is provided with a heating unit into which the liquefied natural gas enters to be heated and to return to the gaseous state before reaching the engine.

The tank in the aforementioned vehicles is filled through the use of a dispenser of cryogenic liquid which refueling stations are provided with.

The dispensers of cryogenic liquid of known type comprise a dispensing apparatus, fastened onto the ground and connected to a cryogenic liquid supply assembly in a fluid-operated manner, and one or more dispensing guns connected to the dispensing apparatus by means of a special hose.

Dispensing guns are provided with a dispensing mouth of cryogenic liquid that can be connected to a refueling tank.

When refueling liquefied natural gas, the vehicle is positioned in the proximity of the dispenser and an operator holds the liquid dispensing gun and connects the dispensing nozzle to the outer port of the tank of the vehicle.

The supply assembly is activated and the liquefied natural gas is introduced into the tank.

The dispensers of cryogenic liquid of known type are also provided with holders for dispensing guns with which the latter are associated when not in use.

Preferably, such holders are associated with the dispensing apparatus and comprise a housing compartment within which the dispensing mouth is fitted.

The use of dispensers of cryogenic liquid of known type has however some drawbacks that are mainly related to the low dispensing temperatures of cryogenic liquid.

Particularly, during the dispensing of cryogenic liquid, the hose and the dispensing mouth, being in contact with a very cold liquid (at −160 °C in the case of liquefied natural gas), cool down in turn.

Moisture in the air surrounding the dispenser frosts on the outer surface of the dispensing gun, thus generating a layer of ice which can damage the mechanical components of the dispensing gun, especially the seals with which the dispensing mouth is provided.

Particularly in cases where several refueling operations are carried out one after the other, i.e., with the gun still frozen, damage can occur to the seals which, being made of elastically deformable material, stiffen and can split.

In detail, when a subsequent refueling operation is carried out, the layer of ice where the seals are located is crushed between the dispensing mouth and the tank port, possibly tearing the seals themselves.

In addition, the presence of the layer of ice generates uneven distribution of the forces involved in tightening on the surface of the seals, resulting in different mechanical stresses that lead to early wear of the seals themselves.

Again, water resulting from ice melting can freeze again, which implies the same problems previously discussed. In fact, thawing water can creep in between the seals and, in the case of a new dispensing operation, freeze virtually instantly, thus generating point stress on the seals themselves due to the increase in volume associated with ice formation.

Such circumstances require frequent maintenance of the dispensing device which specifically involves replacing the seals.

The event of imperfect seal operation, being unpredictable, poses a hazard towards the operators due to the leakage of liquid during the dispensing phase.

These activities result in increased costs in the operation of refueling facilities.

It is a common practice among operators in refueling stations to move the dispensing mouth away from its respective holder to position it at sunny areas so as to promote ice melting.

Positioning the dispensing mouth away from the holder dedicated thereto can be dangerous and result in accidental damage to the same.

In addition to this, ice melting can lead to water pooling on the pavement around the dispenser, which can be dangerous for operators and customers of the refueling station, who may inadvertently slip and hurt themselves.

Such a dangerous situation for people's health can be further worsened in case of very cold outdoor temperatures that lead to freezing such water stagnation, making the pavement even more slippery.

It should be noted, in any case, that at refueling stations of known type such circumstances occur even when the dispensing gun is stowed in its holder.

### DESCRIPTION OF THE INVENTION

The main aim of the present invention is to devise a dispenser of cryogenic liquid and a holder for a dispensing gun of cryogenic liquid which allow reducing the damage to the mechanical components of the dispenser, especially the seals.

Another object of the present invention is to devise a dispenser of cryogenic liquid and a holder for a dispensing gun of cryogenic liquid which allow reducing the frequency with which maintenance jobs are carried out on the dispenser itself.

Still another object of the present invention is to devise a dispenser of cryogenic liquid and a holder for a dispensing gun of cryogenic liquid which allow reducing the occurrence of potentially safety-hazardous conditions and, in particular, events that may endanger the health of operators and/or customers of the refueling station.

Another object of the present invention is to devise a dispenser of cryogenic liquid and a holder for a dispensing gun of cryogenic liquid which allow the aforementioned drawbacks of the prior art to be overcome within the framework of a simple, rational, easy and effective to use, as well as cost-effective solution.

The aforementioned objects are achieved by this dispenser of cryogenic liquid having the characteristics of claim 1.

The aforementioned objects are also achieved by a holder for a dispensing gun of cryogenic liquid having the characteristics of claim 18.

### BRIEF DESCRIPTION OF THE DRAWINGS

Other characteristics and advantages of the present invention will become more apparent from the description of a preferred, but not exclusive, embodiment of a dispenser of cryogenic liquid, illustrated by way of an indicative, yet non-limiting example, in the accompanying tables of drawings in which:

FIG. 1 is an axonometric view of a dispenser according to the invention;

FIG. 2 is an exploded view of some components of the dispenser according to the invention;

FIG. 3 is a cross-sectional view of some components of the dispenser according to the invention in a first configuration of use;

FIG. 4 is a cross-sectional view of the components in FIG. 3 in a different configuration of use from that shown in FIG. 3.

### EMBODIMENTS OF THE INVENTION

With particular reference to these figures, reference numeral 1 globally denotes a dispenser of cryogenic liquid.

In the context of the present disclosure, the term “cryogenic liquid” refers to a substance that under normal conditions of temperature and pressure is in the gaseous state and that, following cooling and condensation operations, is converted to the liquid state.

Within this disclosure, cryogenic liquid is preferably a combustible substance, such as, e.g., natural gas or hydrogen.

Specifically, the cryogenic liquid is at a temperature of about −160 °C, in the case of natural gas, and −240 °C in the case of hydrogen.

This dispenser can also be used with cryogenic liquids of different types, such as nitrogen (−200 °C).

The dispenser 1 comprises at least one dispensing apparatus 2 fastened onto the ground and connected to a supply assembly of a cryogenic liquid in a fluid-operated manner.

Preferably, the dispensing apparatus 2 comprises a vertically-extending post element 3 and a base 4 fastened onto the pavement of the refueling station.

The post element 3 is associated inferiorly with the base 4.

The cryogenic liquid supply assembly, not shown in the figures for pure representational simplicity, is preferably provided with a liquefaction plant or with a cryogenic liquid storage tank and a pick-up line located between it and the dispensing apparatus 2 in a fluid-operated manner.

The pick-up line is activated upon refueling and is adapted to take the cryogenic liquid from the liquefaction plant or from the storage tank and to send it to the dispensing apparatus 2.

The dispenser 1 comprises at least one dispensing gun 5 associated with the dispensing apparatus 2, connectable to a feeding tank and adapted to dispense the cryogenic liquid into the tank.

Specifically, “refueling tank” refers to the tank of a vehicle, such as e.g. a heavy wheeled vehicle, or a generic storage tank.

Conveniently, the dispensing gun 5 comprises at least one dispensing mouth 7 connectable to the tank.

The dispensing gun 5 is connected to the dispensing apparatus 2 by interposition of a hose 6.

The hose 6 is of the type of a tubular body, made of substantially flexible material, and is associated, at one end, with the dispensing gun 5 and, at the other end, with the dispensing apparatus 2.

In more detail, the hose 6 is connected to the pick-up line of the supply assembly in a fluid-operated manner and transfers the cryogenic liquid from the latter to the dispensing gun 5.

The hose 6 is connected to the dispensing gun 5 on the opposite side from where the dispensing mouth 7 is located.

Again, the hose 6 is fastened to the dispensing apparatus 2 and, being made of substantially flexible material, can be easily moved radially around that fastening point so that the dispensing gun 5 can be positioned at various points arranged radially around the dispensing apparatus 2.

In this way, it is possible to easily fill the tank of the vehicle, regardless of its positioning with respect to the dispenser 1, when placed within the movement radius of the hose 6.

In the particular embodiment shown in the figures, the dispenser 1 comprises two dispensing guns 5 associated with the base 4 and arranged where two opposite sides of the post element 3 are located.

Alternative embodiments of the dispenser 1 cannot however be ruled out wherein there is only one dispensing gun 5 or more than two dispensing guns 5.

Again, alternative embodiments of the dispenser 1 cannot be ruled out wherein the dispensing gun 5 may be arranged differently than what shown in the figures and, e.g., be associated with the post element 3.

The dispensing apparatus 2 comprises at least one support 8 adapted to hold, at least partly, the dispensing gun 5 when not in use.

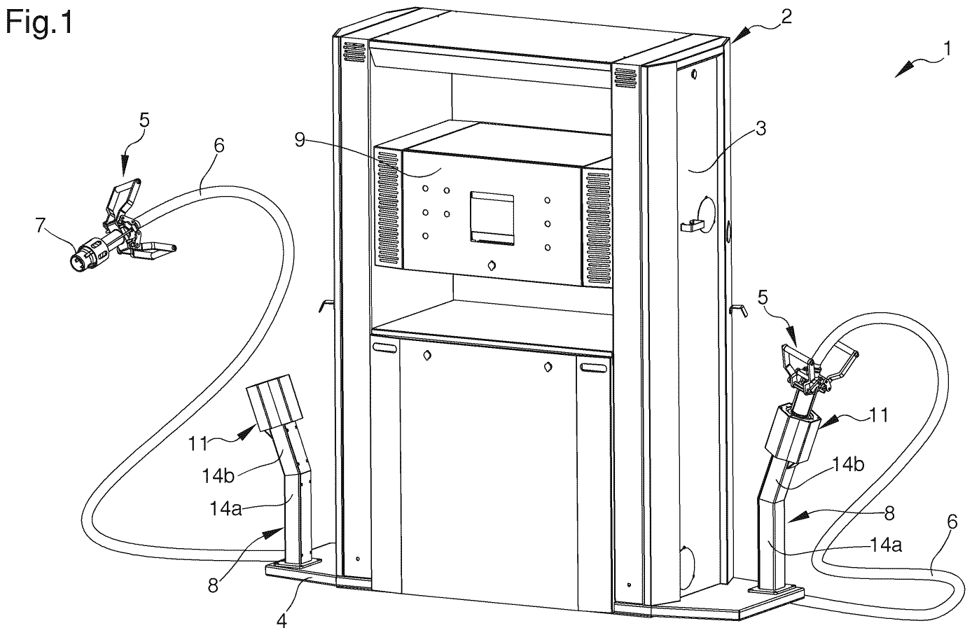

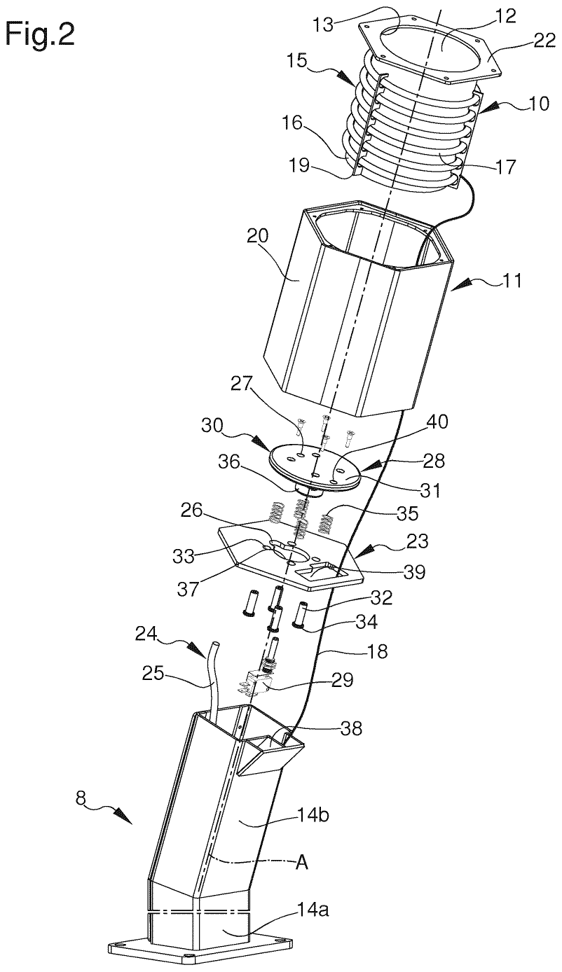

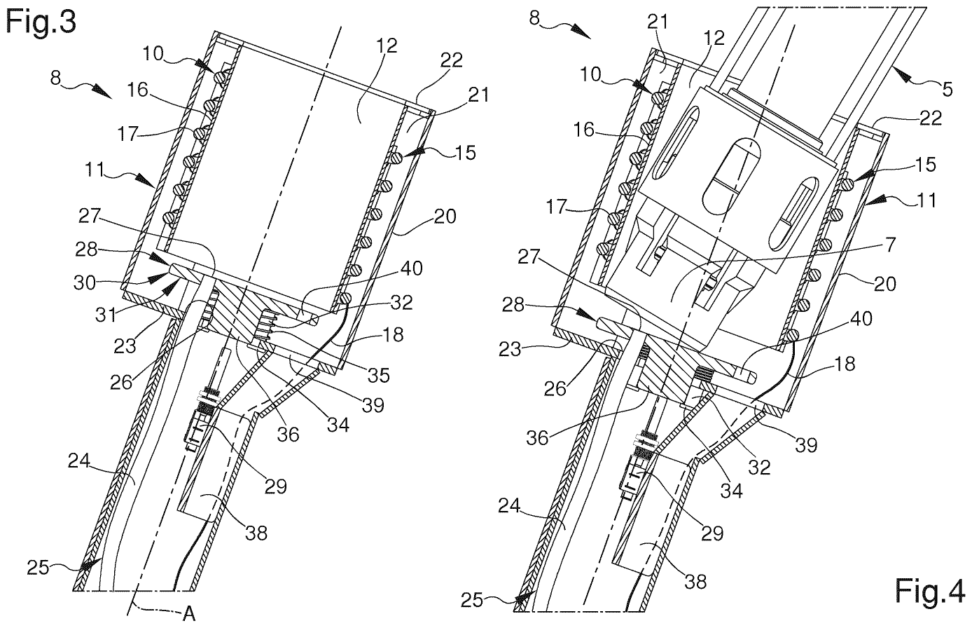

Two supports 8 are shown in FIG. 1, that is, there is one support 8 for each dispensing gun 5.

The supports 8 are associated with the base 4 where two opposite sides of the post element 3 are located.

As will be described in detail below and as shown in FIG. 1, the support 8 defines a housing compartment within which the dispensing mouth 7 of the dispensing gun 5 is arranged.

FIG. 1 particularly shows a dispensing gun 5 associated with the relevant support 8 and a dispensing gun 5 moved away from the relevant support 8 and ready to be possibly used to dispense the cryogenic liquid.

Conveniently, the dispenser 1 comprises at least one management and control unit operationally configured to control the operation of the dispenser 1.

Specifically, the management and control unit, which is not shown in the figures for pure representational simplicity, is operationally connected to the cryogenic liquid supply assembly and to the dispensing gun 5 and is operationally configured to manage the operation of the above components.

Particularly, when it is necessary to dispense the cryogenic liquid, the management and control unit sends an activation signal to the supply assembly and, specifically, activates the pick-up line that sends the cryogenic liquid to the dispensing gun 5.

Then, when it is necessary to get the cryogenic liquid out of the dispensing gun 5, the management and control unit commands the opening of the dispensing mouth 7.

In this regard, it is worth noting that the dispenser 1 comprises user interface means 9 associated with the dispensing apparatus 2 and operationally connected to the management and control unit.

Upon refueling, a user communicates, through the user interface means 9, a start refueling signal to the control management unit, which activates the pick-up line, and then a signal to open the dispensing mouth 7.

The user interface means 9, e.g., comprise a display element for displaying the amount of cryogenic liquid dispensed.

The user interface means 9 also comprise one electronic device for reading an electronic payment card and/or cash to enable the user of the dispenser 1 to pay for the cryogenic liquid introduced in the tank.

According to the invention, the dispenser 1 comprises at least one heat treatment assembly 10 associated with the dispensing apparatus 2 and adapted to heat at least partly the dispensing gun 5 to obtain at least the melting of the ice formed on the dispensing gun 5 as a result of the dispensing of the cryogenic liquid.

As described above, the cryogenic liquid dispensed from the dispensing gun 5 is at a temperature significantly below 0 °C, leading to the freezing of moisture in the air and to the formation of a layer of ice on the dispensing gun 5.

The heat treatment assembly 10 is adapted to heat the dispensing gun 5 so as to melt the layer of ice thereon.

Preferably, the heat treatment assembly 10 is associated with the support 8 and heats the dispensing gun 5 when associated with the support 8 itself.

In addition to this, as will be described in more detail later in this disclosure, the heat treatment assembly 10 is further configured to dry the dispensing gun 5.

As stated above, in fact, according to known methods, the dispensing gun 5 can be positioned in sunny areas to cause the melting of ice formed during dispensing.

However, especially in the case of close refueling, such an operation is unlikely to also cause the complete drying of the dispensing gun itself. Therefore, the dispenser 1 according to the invention also enables the aforementioned technical problem to be solved.

Advantageously, the dispensing apparatus 2 comprises at least one supporting body 11 defining a cavity 12 adapted to house at least partly the dispensing mouth 7.

The supporting body 11 is provided at the top with at least one access opening 13 for the insertion/extraction of the dispensing mouth 7 into/from the cavity 12.

The heat treatment assembly 10 is associated with the supporting body 11.

In actual facts, as previously anticipated, each support 8 defines a compartment for housing the dispensing mouth 7 which, specifically, consists of the cavity 12.

Each support 8 comprises a relevant supporting body 11 and a supporting tubular element 14a, 14b developing longitudinally along a substantially vertical axis and associated, at its lower end, with the base 4 and, at its upper end, with the supporting body 11.

In other words, the supporting tubular element 14a, 14b holds the supporting body 11 from below and the dispensing mouth 7 is arranged to rest within the cavity 12 defined by the supporting body 11.

In more detail, the supporting tubular element 14a, 14b comprises a first longitudinal portion 14a which is substantially vertical, associated with the base 4, and a second longitudinal portion 14b positioned between the first longitudinal portion 14a and the supporting body 11 and arranged transversely to the first longitudinal portion 14a to promote the insertion/extraction of the dispensing mouth 7 into/from the cavity 12.

Conveniently, the heat treatment assembly 10 comprises heating means 15 associated with the supporting body 11 and adapted to heat the cavity 12.

Advantageously, the supporting body 11 comprises at least one inner wall 16 partly defining the cavity 12.

With particular reference to the embodiment shown in the figures, the inner wall 16 has a substantially tubular conformation and develops longitudinally along an axis of development A.

Conveniently, the axis of development A is substantially coincident with the axis of longitudinal development of the second longitudinal portion 14b of the supporting tubular element 14a, 14b.

The access opening 13 is substantially circular and the axis of development A is arranged centrally to the access opening 13.

Conveniently, the heating means 15 are arranged to wrap around the inner wall 16, externally to the cavity 12.

Preferably, the heating means 15 comprise at least one heating element 17 wrapped in a spiral fashion around the inner wall 16.

For example, the heating element 17 is of the type of an electric resistance heating element.

The heating element 17 is connected to a power supply network (not shown in the figures) through a power cord 18, with which the heating means 15 are provided.

The power cord 18 is connected to the heating element 17 where the lower portion of the inner wall 16 is located, descends to the inside of the supporting tubular element 14a, 14b and runs through it by connecting to the power supply network.

The heating element 17, the power cord 18 and the power supply network define an electrical circuit within which the electric current flows.

In this way, the heating element 17 heats up thanks to the joule effect and radiates heat towards its surroundings, i.e., towards the cavity 12.

Conveniently, the supporting body 11 comprises a plurality of holding bars 19 associated with the inner wall 16, externally to the cavity 12, and developing longitudinally parallel to the axis of development A.

The holding bars 19 are adapted to hold the heating element 17.

Precisely, each holding bar 19 comprises a plurality of openings within which the heating element 17 is made to pass during the relevant spiral winding around the inner wall 16.

Conveniently, the supporting body 11 comprises at least one outer wall 20 adapted to define an inter-space 21 with the inner wall 16.

The heating means 15 are arranged inside the inter-space 21.

In actual facts, the heating element 17 is placed inside the inter-space and is thus isolated from the external environment.

With particular reference to the embodiment shown in the figures, the outer wall 20 has a closed development and a substantially elongated conformation along the axis of development A.

The outer wall 20 is arranged around the inner wall 16.

The supporting body 11 comprises a substantially flat upper wall 22 positioned between the inner wall 16 and the outer wall 20 and adapted to close the inter-space 21 at the top.

The upper wall 22 develops around the access opening 13 and is arranged substantially orthogonal to the axis of development A.

Advantageously, the supporting body 11 comprises at least one bottom wall 23.

The bottom wall 23 is substantially flat, is associated with the outer wall 20 and is adapted to close inferiorly the inter-space 21.

The bottom wall 23 is arranged substantially orthogonal to the axis of development A.

The bottom wall 23 is associated with the supporting tubular element 14a, 14b.

Precisely, the bottom wall 23 is associated with the second longitudinal portion 14b of the supporting tubular element 14a, 14b.

Advantageously, the heat treatment assembly 10 comprises blowing means 24 associated with the supporting body 11 and adapted to distribute at least one working gas within the cavity 12.

The heating means 15 and the blowing means 24 operate in conjunction to heat the cavity 12.

The working gas is of the type of a compressed gas.

Preferably, the working gas is of the compressed air type.

Specifically, the working gas, once it enters the cavity 12, is heated in turn by the heating means 15 and promotes heat distribution within the cavity 12.

In accordance with an alternative embodiment of the dispenser 1, not shown in the figures, the working gas is of the heated air type.

In actual facts, the combined action of the heating means 15 and of the blowing means 24 generates a jet of hot air within the cavity 12 that promotes the melting of the ice deposited on the dispensing mouth 7 and promotes the detachment of water droplets from the same dispensing mouth 7.

Therefore, in addition to causing the ice to melt, the blowing means 24 also promote the drying of the dispensing gun 5.

As will be described later, such water is removed from the cavity 12 through a special drainage system with which the dispenser 1 is provided.

Conveniently, the blowing means 24 comprise:
at least one blowing channel 25 connected to the cavity 12 in a fluid-operated manner;
at least one feeding device of the working gas connected to the blowing channel 25 in a fluid-operated manner and adapted to send the working gas to the blowing channel 25.

The blowing channel 25 has a substantially tubular conformation, is arranged within the supporting tubular element 14a, 14b, and is connected to the supporting body 11 in a fluid-operated manner.

As will be described later in detail, the supporting body 11 defines a through hole 26 and a blowing hole 27 through which the blowing channel 25 enters the inside of the cavity 12 in order to distribute the working gas within the latter.

Preferably, the feeding device of the working gas is of the type of a compressor associated with the dispensing apparatus 2.

Alternatively, the feeding device of the working gas is of the type of a hydraulic connection channel to an external feeding source of the working gas.

Conveniently, the heat treatment assembly 10 comprises actuating means 28 adapted to activate/deactivate at least one of either the heating means 15 or the blowing means 24.

The actuating means 28 comprise:
at least one switch 29 adapted to operate at least one of either the heating means 15 or the blowing means 24;
at least one operating device 30 associated with the supporting body 11 in a sliding manner, internally to the cavity 12, and positionable between a first position, wherein it is moved away from the switch 29 and prevents at least one of either the heating means 15 or the blowing means 24 from being activated, and a second position, wherein it is moved close to and operates on the switch 29 as a result of the interaction with the dispensing mouth 7 and allows the activation of at least one of either the heating means 15 or the blowing means 24.

According to the preferred embodiment, the actuating means 28 operate only on the blowing means 24, and specifically, the switch 29 and the operating device 30 operate synergistically to activate/deactivate the blowing means 24.

The heat treatment assembly 10 advantageously comprises a temperature control device, not shown in detail in the figures, configured to deactivate the heating means 15 when the temperature inside the cavity 12 is equal to or above a preset value.

The temperature control device is connected to the power cord 18 and causes the interruption of the current flow when the desired temperature is reached.

However, alternative embodiments of the dispenser 1 cannot be ruled out wherein the temperature control device is not provided.

Preferably, the switch 29 is of the type of a microswitch.

The switch 29 is internally associated with the supporting tubular element 14a, 14b.

Precisely, the switch 29 is arranged in the proximity of the bottom wall 23 of the supporting body 11.

The switch 29 is operationally connected to the feeding device of the working gas and controls the switching on or off thereof.

Specifically, when the operating device 30 is in the second position, that is, it interacts with the switch 29, the gas feeding device is activated and sends compressed air to the blowing channel 25 which distributes it within the cavity 12.

To interrupt the distribution of compressed air within the cavity 12, it is necessary to switch the gas feeding device off, by placing the operating device 30 to the first position.

Alternatively and/or in combination thereof, the heat treatment assembly 10 comprises a timer device which is adapted to switch the working gas feeding device off after a specified time interval after it has been switched on.

The operating device 30 comprises at least one holding element 31 adapted to receive and support the dispensing mouth 7.

The holding element 31 has a substantially circular conformation and is arranged at the base of the cavity 12, where the bottom wall 23 is located.

The holding element 31 has a median axis substantially coincident with the axis of development A.

In other words, the holding element 31 is centered with respect to the cavity 12. The holding element 31 is provided with a holding surface facing the access opening 13.

The holding element 31 is also provided with a projecting abutment member 36 facing the bottom wall 23.

The abutment member 36 has a substantially cylinder conformation, the axis of which coincides with the axis of development A.

In the second position, the abutment member 36 operates the switch 29.

To this end, conveniently, the bottom wall 23 comprises at least one through opening 37 and the abutment member 36 is insertable/extractable into/from the through opening 37 when moving between the first position and the second position.

The through opening 37 has a substantially circular conformation, the center of which belongs to the axis of development A.

The operating device 30 comprises at least one elastic retaining element 35 positioned between the holding element 31 and the bottom wall 23 and adapted to keep the holding element 31 in the first position.

The holding element 31 can be positioned in the second position as a result of the application of a counteracting force to the elastic retaining element 35 exerted by the weight of the dispensing mouth 7.

The elastic retaining element 35 is of the type of a spring.

In detail, when the operating device 30 is in the second position, the elastic retaining element 35 is stretched out and keeps the holding element 31 away from the bottom wall 23, thus preventing the holding element 31 from sliding close to the bottom wall 23.

Precisely, the abutment member 36, in this particular configuration, is extracted from the through opening 37 and does not contact the switch 29.

As a result of the insertion of the dispensing mouth 7 into the cavity 12, the elastic retaining element 35 is contracted by virtue of the weight force exerted by the dispensing mouth 7 on the holding element 31.

In this particular configuration, the abutment member 36 is inserted into the through opening 37 and contacts the switch 29 leading to the activation of the feeding device of the working gas.

The operating device 30 comprises at least one connecting element 32 fastened to the holding element 31 and associated with the bottom wall 23 in a sliding manner.

The elastic retaining element 35 is associated with the connecting element 32.

Specifically, the elastic retaining element 35 is wrapped around the connecting element 32.

Particularly, the connecting element 32 has a substantially elongated conformation along a longitudinal axis of development substantially parallel to the axis of development A and extends from the holding element 31 towards the bottom wall 23.

Conveniently, the bottom wall 23 comprises at least one connecting hole 33 into which the connecting element 32 is inserted in a through manner.

Precisely, the connecting element 32 is inserted within the connecting hole 33 in a sliding manner along the axis of development A.

Conveniently, the connecting element 32 comprises a securing element 34 adapted to prevent it from slipping out of the connecting hole 33 during the sliding along the axis of development A.

Particularly, the securing element 34 defines an end-of-stroke stop when the operating device 30 is moved away from the bottom wall 23.

In the particular embodiment shown in the figures, the operating device 30 comprises a plurality of connecting elements 32 which are arranged radially around the geometric center of the holding element 31.

At the same time, the bottom wall 23 comprises a plurality of connecting holes 33.

The operating device 30 also comprises a plurality of elastic retaining elements 35, where each elastic retaining element 35 is associated with a respective connecting element 32.

As previously described, the bottom wall 23 comprises at least one through hole 26 and the blowing channel 25 runs through the through hole itself.

In the particular embodiment shown in the figures, the through hole 26 is obtained adjacent to the through opening 37.

The holding element 31 comprises at least one blowing hole 27 and the blowing channel 25 is connected to the blowing hole 27 in a fluid-operated manner.

The blowing hole 27 is obtained on the holding element 31 and is aligned with the through hole 26.

Conveniently, the blowing channel 25 is made of a substantially flexible material so as not to hinder the movement of the operating device 30 between the first position and the second position.

In accordance with an alternative embodiment, not shown in the figures, the actuating means comprise a proximity sensor, which is connected to the blowing means 24 and configured to detect the presence of the dispensing mouth 7 within the cavity 12. The proximity sensor can be of the type of an inductive sensor and, therefore, can detect the presence of the dispensing mouth 7 when placed in contact therewith, or it can be of the type of a distance sensor, that is, capable of detecting the presence of the dispensing mouth 7 when not in contact therewith.

Conveniently, the dispenser 1 comprises at least one drainage channel 38 connected to the bottom wall 23 and adapted to convey the water generated in the cavity 12 and resulting from the melting of ice towards a collection tank.

Preferably, the drainage channel 38 is arranged below the bottom wall 23 and is positioned within the supporting tubular element 14a, 14b.

Advantageously, the bottom wall 23 comprises at least one drainage hole 39, the drainage channel 38 being associated with the drainage hole 39.

The holding element 31 comprises at least one outlet hole 40 connected to the drainage hole 39 in a fluid-operated manner.

The drainage hole 39 and the outlet hole 40 are substantially aligned.

In this way, the water leaving the outlet hole 40 falls by gravity into the drainage channel 38 passing through the drainage hole 39.

A further aspect of the present invention relates to a support 8 for a dispensing gun 5 of cryogenic liquid comprising:
at least one supporting body 11 defining a cavity 12 adapted to house at least partly the dispensing gun 5;
at least one heat treatment assembly 10 associated with the supporting body 11 and adapted to heat at least partly the cavity 12.

The operation of the dispenser 1 according to the invention is as follows.

An operator in charge of refueling operations uses the user interface means 9 to activate, through the management and control unit, the pick-up line.

Next, he/she holds the dispensing gun 5, pulls out the dispensing mouth 7 from the supporting body 11 and connects the dispensing mouth 7 to the tank to be filled.

Through the user interface means 9 the operator controls the opening of the dispensing mouth 7 so that the cryogenic liquid can flow out and fill the tank.

During dispensing, the moisture present in the air condensates and freezes externally to the dispensing gun 5 and, particularly, to the dispensing mouth 7.

After the filling phase is finished, the operator inserts the dispensing mouth 7 within the cavity 12, which is heated up by the heating means 15.

The insertion of the dispensing mouth 7 into the supporting body 11 results in the movement of the operating device 30 to the second position and the operation of the switch 29.

In this way, the blowing means 24 are activated and the working gas is conveyed into the cavity 12.

At the same time, the heating means 15 also heat up the working gas so as to achieve the melting of the ice present on the dispensing mouth 7.

Subsequently, the water formed within the cavity 12 flows out of the same through the drainage hole 39 and through the outlet hole 40 and is moved away through the drainage channel 38.

When it is necessary to dispense again the cryogenic liquid from the dispenser 1, the user again picks up the dispensing gun 5 by pulling the dispensing mouth 7 out of the cavity 12.

By doing so, the operating device 30 returns to the first position by means of the elastic retaining elements 35 and the blowing means 24 are deactivated.

It has in practice been ascertained that the described invention achieves the intended objects.

In particular, the fact of providing a dispenser of cryogenic liquid and a holder for the dispensing gun of cryogenic liquid provided with a heat treatment assembly that heats, at least partly, the dispensing gun allows reducing the damage to the mechanical components of the dispenser, especially the seals.

Specifically, thanks to the heat treatment assembly, the melting of ice formed on the dispensing gun is achieved so as to reduce or eliminate the presence of ice and water on the seals at the next dispensing.

This enables longer preservation of such components, which are less prone to failure.

It is also possible to limit the frequency with which the maintenance jobs are carried out on the dispenser and to contain the operating and maintenance costs of the same.

Additionally, thanks to the presence of the heat treatment assembly, it is also possible to improve the level of safety related to the use of the dispenser since it is possible to limit the occurrence of potentially hazardous safety conditions and, in particular, events which may endanger the health of the operators and/or customers of the refueling station.

1) Dispenser of cryogenic liquid comprising:
at least one dispensing apparatus fastened onto the ground and connected to a supply assembly of a cryogenic liquid in a fluid-operated manner;
at least one dispensing gun associated with said dispensing apparatus, connectable to a feeding tank and adapted to dispense said cryogenic liquid into said tank;
further comprising at least one heat treatment assembly associated with said dispensing apparatus and adapted to heat at least partly said dispensing gun to obtain at least the melting of ice formed on said dispensing gun as a result of the dispensing of said cryogenic liquid.

2) Dispenser according to claim 1, wherein said dispensing gun comprises at least one dispensing mouth connectable to said tank and by the fact that said dispensing apparatus comprises at least one supporting body defining a cavity adapted to house at least partly said dispensing mouth, said supporting body being provided at the top with at least one access opening for the insertion/extraction of said dispensing mouth into/from said cavity and said heat treatment assembly being associated with said supporting body.

3) Dispenser according to claim 1, wherein said heat treatment assembly comprises heating means associated with said supporting body and adapted to heat said cavity.

4) Dispenser according to claim 1, wherein said supporting body comprises at least one inner wall partly defining said cavity, said heating means being arranged to wrap said inner wall externally to said cavity.

5) Dispenser according to claim 1, wherein said heating means comprises at least one heating element wrapped in a spiral fashion around said inner wall.

6) Dispenser according to claim 1, wherein said supporting body comprises at least one outer wall adapted to define an inter-space with said inner wall, said heating means being arranged within said inter-space.

7) Dispenser according to claim 1, wherein said supporting body comprises at least one bottom wall and by the fact that said dispenser comprises at least one drainage channel connected to said bottom wall and adapted to convey towards a collection tank the water generated in said cavity and resulting from the melting of said ice.

8) Dispenser according to claim 1, wherein said heat treatment assembly comprises blowing means associated with said supporting body and adapted to distribute at least one working gas within said cavity said heating means and said blowing means operating in conjunction to heat said cavity.

9) Dispenser according to claim 1, wherein said blowing means comprise:
at least one blowing channel connected to said cavity in a fluid-operated manner;
at least one feeding device of said working gas connected to said blowing channel in a fluid-operated manner and adapted to send said working gas to said blowing channel.

10) Dispenser according to claim 1, wherein said heat treatment assembly comprises actuating means adapted to activate/deactivate at least one of either said heating means or said blowing means.

11) Dispenser according to claim 1, wherein said actuating means comprise:
at least one switch adapted to operate at least one of either said heating means or said blowing means;
at least one operating device associated with said supporting body in a sliding manner, internally to said cavity, and positionable between a first position, wherein it is moved away from said switch and prevents at least one of either said heating means or said blowing means to be activated, and a second position, wherein it is moved close and operates on said switch as a result of the interaction with said dispensing mouth and allows the activation of at least one of either said heating means or said blowing means.

12) Dispenser according to claim 1, wherein said operating device comprises at least one holding element adapted to receive and support said dispensing mouth and provided with a projecting abutment member facing said bottom wall wherein, in said second position, said abutment member operates said switch.

13) Dispenser according to claim 1, wherein said bottom wall comprises at least one through opening, said abutment member being insertable/extractable into/from said through opening when moving between said first position and said second position.

14) Dispenser according to claim 1, wherein said operating device comprises at least one elastic retaining element positioned between said holding element and said bottom wall and adapted to keep said holding element in said first position, said holding element being positionable in said second position as a result of the application of a counteracting force to said elastic retaining element exerted by the weight of said dispensing mouth.

15) Dispenser according to claim 1, wherein said operating device comprises at least one connecting element fastened to said holding element and associated with said bottom wall in a sliding manner, said elastic retaining element being associated with said connecting element.

16) Dispenser according to claim 1, wherein:
said bottom wall comprises at least one through hole said blowing channel passing through said through hole
said holding element comprises at least one blowing hole, said blowing channel being connected to said blowing hole in a fluid-operated manner.

17) Dispenser according to claim 1, wherein:
said bottom wall comprises at least one drainage hole, said drainage channel being associated with said drainage hole;
said holding element comprises at least one outlet hole connected to said drainage hole in a fluid-operated manner.

18) Holder for a dispensing gun of cryogenic liquid further comprising:
at least one supporting body defining a cavity adapted to house at least partly said dispensing gun;
at least one heat treatment assembly associated with said supporting body and adapted to heat at least partly said cavity.
